(19) United States
(12) Patent Application Publication
(10) Pub. No.: US 2012/0054303 A1
(43) Pub. Date: Mar. 1, 2012

(54) CONTENT DELIVERY BASED ON TEMPORAL CONSIDERATIONS

(75) Inventors: Eswar Priyadarshan, West Roxbury, MA (US); Kenley Sun, Cambridge, MA (US); Ravikiran Chittari, Cupertino, CA (US); Jayasurya Vadrevu, Lexington, MA (US)

(73) Assignee: Apple Inc., Cupertino, CA (US)

(21) Appl. No.: 12/873,260

(22) Filed: Aug. 31, 2010

(51) Int. Cl. G06F 15/16

(52) U.S. Cl. 709/217

(57) ABSTRACT

Invitational content can be served to a user taking into account temporal considerations. By using temporal considerations, such as dayparts having a relationship to the content or the user, the content delivery system can better associate content to users to increase the relevance of the content to the user, to increase the user's interest in the content, and to increase the performance of the content delivery system as judged by the meeting of system objectives.

### BACKGROUND

1. Technical Field

The present disclosure relates to electronic content delivery and more specifically to intelligent targeting of invitational content to a user based on time-of-day and day-of-week considerations.

2. Introduction

Targeted content delivery has long been an accepted means of conveying a desired message to an audience. Instead of creating a single message and delivering it to every member of the general public, content providers attempt to identify a particular segment of the population that is likely to have the greatest interest in their message. Many factors can go into identifying the right segment of the population, but prior art techniques are mostly evolved from traditional broadcast content targeting, which ignores many forms of available data, or doesn't process available data quickly enough to use the data to identify the right segment of the population.

More recently electronic content delivery systems have been employed to deliver content to electronic devices. While these systems are using more of the available data than traditional content targeting systems, how this additional information can be used is still a work in progress.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The present technology relates to delivery of electronic content based on temporal considerations. In some embodiments, a day can be divided into one or more dayparts that are correlated to variations in the frequency of user interaction with the invitational content. The invitational content can then be associated with the dayparts for which the system has identified as being correlated to a higher frequency of conversion so that the items of invitational content can be prioritized for presentation to users during the same daypart on future occasions.

Such prioritization of content based on daypart allows content to be delivered that is most likely to receive user attention and interest. Content related to work is likely to receive the most interest during work. Content related to grocery shopping is likely to receive the most interest on the weekends when a user is most likely to grocery shop. Entertainment content is most likely to be of interest on days and times when the user is interested in entertainment. Accordingly, the system can monitor the performance of content to determine when the content is of most interest to the users of the system.

In a related fashion, some users may exhibit a predisposition for interacting with content during certain dayparts. Perhaps the user commutes on public transportation and accordingly has free time to view content. Perhaps the user is a student who only has free time in the evenings. Such propensities can be discovered by analyzing data associated with a user's interaction with invitational content. Pattern recognition software or other analytical algorithms can be used for this purpose.

Likewise data related to interaction with more than one item of invitational content, such as a group of content associated with a segment of the user population, can be analyzed to discover when a particular segment is temporally most relevant.

Using the foregoing methods and systems, invitational content can be served to a user taking into account temporal considerations. By using temporal considerations, such as dayparts having a relationship to the content, the segment or the user, the content delivery system can better associate content to users to increase the relevance of the content to the user, to increase the user's interest in the content, and to increase the performance of the content delivery system as judged by the meeting of system objectives, among other benefits.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network;

FIG. 2 illustrates a sampling of events that can be known to the content delivery network;

FIG. 3 illustrates examples of dayparts on a weekday;

FIG. 4 illustrates example of dayparts on a weekend;

FIG. 5 illustrates an exemplary method of recording time information associated with a click, conversion, or other interaction with an item of invitational content;

FIG. 6 illustrates an exemplary method of associating an item of invitational content with dayparts.

FIG. 7 illustrates an exemplary method of recording time information associated with a click, conversion, or other interaction by an identified user;

FIG. 8 illustrates an exemplary method of associating a user's interaction history with dayparts;

FIG. 9 illustrates an exemplary method of selecting an item of invitational content to serve to a user while taking into account daypart data;

FIG. 10 illustrates an exemplary method of selecting an item of invitational content to serve to a user based on the user's history of being a high converter during the present daypart; and

FIG. 11 illustrates an exemplary system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. The present disclosure addresses the need in the art for improved methods of selecting targeted content presented to a user based on characteristics descriptive of the user and/or the user's interaction with one or more items of targeted content.

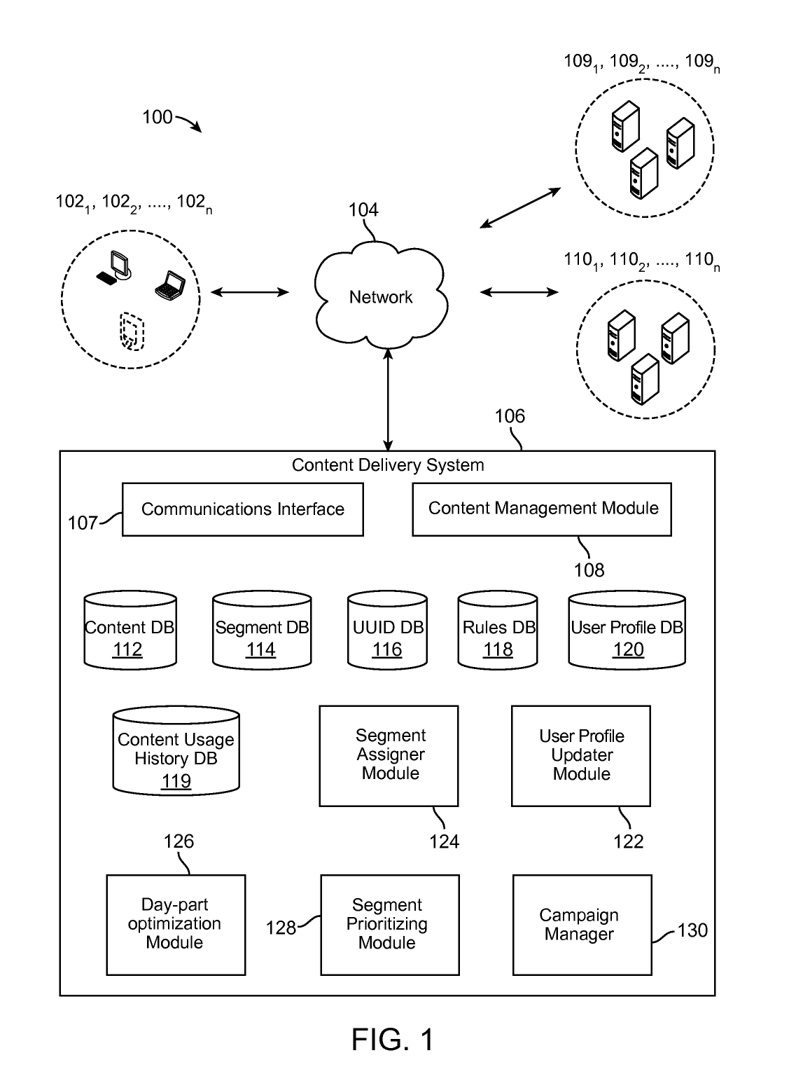

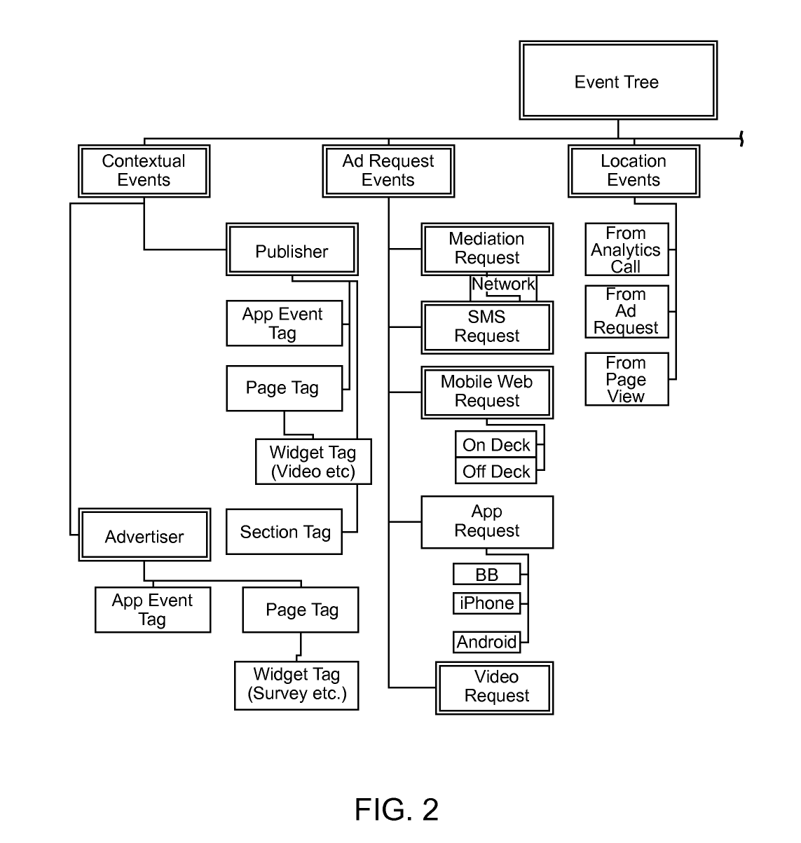

The presently disclosed system and method is particularly useful for matching targeted content with a user in a manner that leads to a higher probability of conversion into an action or interaction. An exemplary system configuration 100 is illustrated in FIG. 1 wherein electronic devices communicate via a network for purposes of exchanging content and other data. The system can be configured for use on a local area network such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, invitational content is delivered to user terminals 102₁ . . . 102ₙ (collectively “102”) connected to a network 104 by direct and/or indirect communications with a content delivery system 106. In particular, the content delivery system 106 receives a request for a content package of electronic-invitational content, such as a web page, an application, a game, or media, etc., from one of user terminals 102. In the various embodiments, one or more types of invitational content can be combined in a content package. The invitational content can include text, graphics, audio, video, executable code or any combination thereof. In some embodiments, the invitational content can be associated with a product or can directly or indirectly advertise a product. In some embodiments, the content package can be configured to replace or update invitational content in a content package already delivered to the user terminal.

Further, the invitational content can be active invitational content. That is, invitational content that is designed to primarily elicit a pre-defined response from the user. For example, active invitational content can include one or more types of advertisements configured to be clicked upon, solicit information, or be converted by the user into a further action, such as a purchase or download of the advertised item. However, invitational content can also include passive invitational content. That is, invitational content that is designed to primarily inform the user. In some cases, passive invitational content can include information that can lead or direct users to active invitational content. Additionally, the invitational content can be dynamic invitational content. That is, invitational content that varies over time or that varies based on user interaction with the invitational content. However, the various embodiments are not limited in this regard and the invitational content can be static invitational content that does not vary over time or that varies based on user interaction. In the various embodiments, an invitational content in a content package can be static or dynamic and active or passive. Further, various types of invitational content can be combined in a same content package.

After receiving the request for invitational content, the content delivery system 106 selects the invitational content in response to the request and transmits the assembled invitational content to the requesting one of user terminals 102. In some embodiments, the server has preselected the invitational content before the request is received. Thereafter, the server assembles a content package of invitational content and causes the content package to be delivered to the user. The content delivery system can include a communications interface 107 to facilitate communications with the user terminals 102 and any other components familiar to those of ordinary skill in the art.

The content delivery system 106 includes a content management module 108 that facilitates generation of the assembled content package, which can include invitational content. Specifically, the content management module can combine content from one or more primary content providers 109₁ . . . 109ₙ (collectively “109”) and content from one or more secondary content providers 110₁ . . . 110ₙ (collectively “110”) to generate the assembled content package for the user terminals 102. For example, in the case of a web page being delivered to a requesting one of user terminals 102, the content management module 108 can assemble a content package by requesting the data for the web page from one of the primary content providers 109 maintaining the web page. For the invitational content on the web page provided by the secondary content providers 110, the content management module 108 can request the appropriate data according to the arrangement between the primary and secondary content providers 109 and 110.

Although, primary and secondary providers 109 and 110 are presented herein as separate entities, this is for illustrative purposes only. In some cases, the primary and secondary providers 109 and 110 can be the same entity. Thus, a single entity can define and provide both the primary and the secondary content.

Although the content management module 108 can be configured to request that content be sent directly from content providers 109 and 110, a cached arrangement can also be used to improve performance of the content delivery system 106 and improve overall user experience. That is, the content delivery system 106 can include a content database 112 for locally storing/caching content maintained by content providers 109 and 110. The data in the content database 112 can be refreshed or updated on a regular basis to ensure that the content in the database 112 is up to date at the time of a request from a user terminal. However, in some cases, the content management module 108 can be configured to retrieve content directly from content providers 109 and 110 if the metadata associated with the data in content database 112 appears to be outdated or corrupted.

In the various embodiments, the content delivery system 106 can also include a unique user identifier (UUID) database 116 that can be used for managing sessions with the various user terminal devices 102. The UUID database 116 can be used with a variety of session management techniques. For example, the content delivery system 106 can implement an HTTP cookie or any other conventional session management method (e.g., IP address tracking, URL query strings, hidden form fields, window name tracking, authentication methods, and local shared objects) for user terminals 102 connected to content delivery system 106 via a substantially persistent network session. However, other methods can be used as well. For example, in the case of handheld communications devices, e.g. mobile phones, smart phones, tablets, or other types of user terminals connecting using multiple or non-persistent network sessions, multiple requests for content from such devices may be assigned to a same entry in the UUID database 116. The delivery system 106 can analyze the attributes of requesting devices to determine whether such requests can be attributed to the same device. Such attributes can include device or group-specific attributes.

As described above, content maintained by the content providers 109 and 110 can be combined according to a predefined arrangement between the two content providers, which can be embodied as a set of rules. In an arrangement where the content delivery system assembles the content package from multiple content providers, these rules can be stored in a rules database 118 in content delivery system 106. The content management module 108 can be configured to assemble the content package for user terminals 102 based on these rules. The rules specify how to select content from secondary content providers 110 and primary content providers 109 in response to a request from one of user terminals 102. For example, in the case of a web page maintained by one of primary content providers 109 and including variable advertisement portions, the rules database 118 can specify rules for selecting one of the secondary providers 110. The rules can also specify how to select specific content from the selected one of secondary providers 110 to be combined with the content provided by one of primary providers 109. Once assembled, the assembled content package can be sent to a requesting one of user terminals 102. However, the content package is not limited to the content from content providers 109 and 110. Rather, the content package can include other data generated at the content delivery system 106.

One concern with the arrangement typically entered into by secondary content providers 110 is that they can result in invitational content of little or no interest being presented to users. As a result, even though a desired number of impressions can be achieved, the rate of response to such invitational content may be low and/or the resulting targeted audience may be incorrect or suboptimal. Additionally, in most content delivery environments, such as that of system 100, the number and type of providers 109 and 110 are generally not static. For example, the number of primary content providers 109 and the amount and type of space they provide for secondary content providers 110 can vary over time. Further, the number of secondary content providers 110 can vary over time, as well as the amount and types of space they require from primary content providers 109. Further, the types of users and user terminals of interest to the secondary content providers 110 can also vary over time. As a result, selecting optimal invitational content to present to a user can quickly become complicated in such a dynamic environment.

The various embodiments disclosed herein provide systems and methods for intelligently targeting invitational content to a user based one or more factors including user characteristics, user contexts, content metadata, content context, spatial information, temporal information, etc.

As used herein, the term “user characteristics” refers to the characteristics of a particular user associated with one or more of user terminals 102. User characteristics can include channel characteristics, demographic characteristics, behavioral characteristics, spatial characteristics, and temporal characteristics. Channel characteristics can define the specific delivery channel being used to deliver a content package to a user. For example, channel characteristics can include a type of electronic content, a type of device or user terminal, a carrier or network provider, or any other characteristic that defines a specific delivery channel for the content package. Spatial or temporal characteristics can define a location, a date, a time, or any other characteristic that defines a geographic location and/or a time for delivery of the content package. Demographic characteristics can define characteristics of the users targeted by the content or associated with the content. For example, demographic characteristics can include age, income, ethnicity, gender, occupation, or any other user characteristics. Behavioral characteristics can define user behaviors for one or more different types of content, separately or in combination with any other user characteristics. That is, different behavioral characteristics may be associated with different channel, demographic, spatial or temporal characteristics. User characteristics can also include characteristics descriptive of a user's state of mind including characteristics indicative of how likely a user is to click on or convert an item of invitational content if it were displayed to the user.

As used herein the term “user context” refers to data about a particular user that provides context to the current state of the user. In some instances “user contexts” can overlap with or be included within “user characteristics,” but “user contexts,” in general provide a current state perspective of a user to provide context to “user characteristics”. For example, a user's current location, even when considered generally, can be informative that the user's present context is associated with being near the user's home, or conversely being on travel away from home. Other contextual data can include, time of day, inferred state of mind (such as an inferred present interest in a particular type of content), etc. “User context” can be used to inform an analysis of “user characteristics” to provide more serious consideration, or higher ranking, or focus on one or more of the “user characteristics.”

Similarly, content too can have related characteristics and contexts. Content characteristics can include information or metadata about the content regarding its topic, type, target audience, and data regarding user interaction with the content, as examples. Content context can include information or metadata about the content related to the circumstances in which the content was displayed to a user or the circumstances in which the content was interacted with by a user. For example, content context about a user's interaction with an item of secondary content displayed within an item of primary content in which the contextual data includes the topic of the primary content, the time of day, the color of the primary content, the color of the secondary content, and/or the type and nature of the interactions with the secondary content by the user. Just as with the user context, the content context can inform an analysis of the secondary content's characteristics.

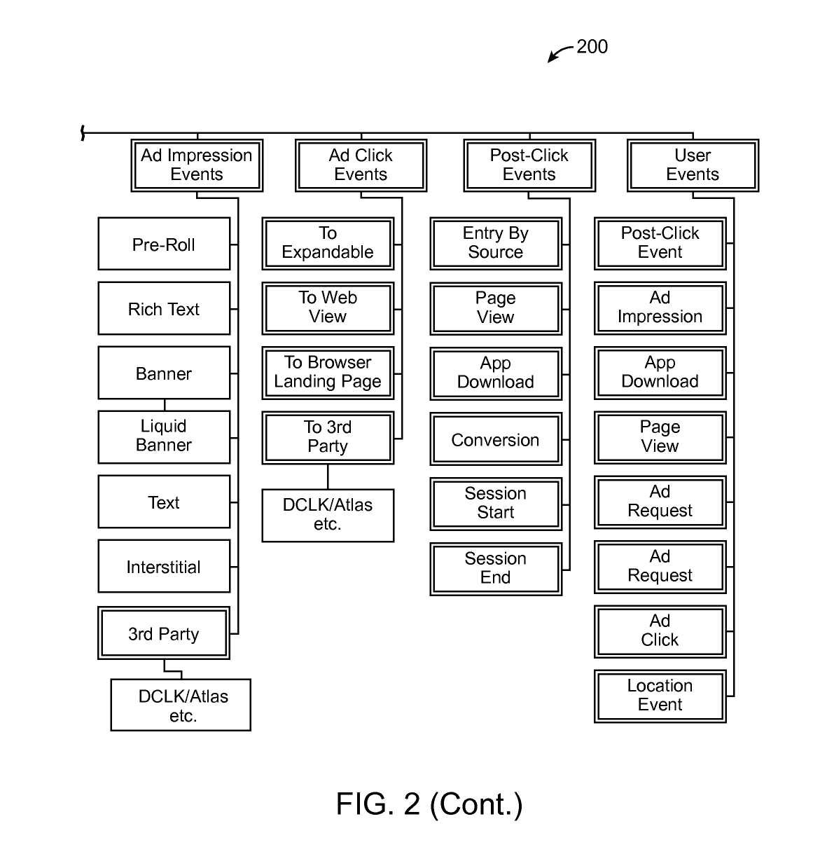

User characteristics, contexts and content characteristics and content can be learned directly or derived indirectly from a variety of sources. For example, the graph 200 in FIG. 2 illustrates a sampling of events from which the delivery system 106 can directly learn characteristics and contexts and/or derive other characteristics or contexts. Even though FIG. 2 illustrates a fair number of events as data sources, the figure should not be considered limiting. As will become apparent from the rest of this disclosure, the delivery system can learn of or derive user characteristics from any number of other information sources.

Referring back to FIG. 1, in some embodiments, the content delivery system 106 can include a user-profile database 120. The user-profile database 120 can, at least in part, be constructed based on recorded user characteristics related to one or more users. In some cases, the user-profile database may contain uncertain or incomplete user characteristic values.

The user-profile database 120 can be updated using a user-profile-updater module 122. In some embodiments, the user-profile-updater module 122 can be configured to add additional profile data, update profile data, fill in missing profile data, or derive uncertain user characteristic values from trusted data.

The updater module 122 can also be configured to maintain the profile database 120 to include only more recently acquired data or to re-derive any uncertain characteristics in order to ensure that the user profile is an accurate reflection of the current state of the user (location, state of mind, behaviors, demographics, etc. can change rapidly). For example, the updater module 122 can be configured to maintain the profile database 120 to include only data from the last two to three months. However, the updater module 122 can be configured to adjust the data in profile database 120 to cover any span of time. In some instances, the updater module 122 can update the profile database 120 in real-time. In some instances, the updater module 122 can update the profile database 120 at least every week, or every day. In some cases, the delivery system 106 can receive a direct request to update one or more user profiles. The update request can come directly from the user's device or any other device capable of communicating with the delivery system 106, such as other content delivery networks or websites. In some cases, the delivery system 106 can receive an indirect request to update one or more user profiles. An indirect request can be the result of receiving new user characteristic values. An update request can occur at any time.

In some embodiments, the content delivery system 106 can include a segment database 114 that is used to aid in selecting invitational content to target to users. The segment database 114 stores defined segments and associations between the segments and users and/or invitational content that should be targeted to users associated with the segments. A targeted segment can be defined based on one or more user characteristics or derivatives thereof and can be associated with one or more items of invitational content. Additionally, a targeted segment can be associated with one or more users. In some embodiments, by associating a targeted segment with both a user and an item of invitational content, the delivery system can match invitational content with users. In some embodiments, the delivery system 106 can update the segment database 114 to add newly defined targeted segments or to delete targeted segments.

In some cases, a targeted segment can be as simple as a single user characteristic identifier and a single user characteristic value. For example, the common demographic identifiers of gender, age, ethnicity, or income can each be used in defining corresponding targeted segments. A characteristic value can also be assigned to the identifier. For example, the values of male, 19, Indian, and $20,000-$30,000 can be assigned to the user characteristics of gender, age, ethnicity, and income, respectively. A user characteristic value associated with a user characteristic can be a single value, multiple values, a range of values, or any combination thereof. A user characteristic value can also be a wildcard value, which indicates that any value is an acceptable match for the user characteristic.

More complex targeted segments can also be defined that consist of one or more identifiers with one or more values associated with each identifier. For example, a targeted segment can be defined to target a user with the following characteristics: gender, male; age, 19-24; location, Northern California but not San Francisco. Targeted segments can also be defined based on spatial-temporal characteristics. For example, a segment can be defined as a bounded region associated with a landmark in the landmark database or a particular location and time. Additional exemplary segments are described throughout this disclosure. Furthermore, targeted segments can correspond to one or more segments that content providers are likely to easily understand and thus can quickly identify as being relevant to their content.

In some embodiments, the content delivery system 106 can provide a segment assigner module 124. The segment assigner module 124 can apply a set of user characteristics associated with a user (including segments to which a user has been previously assigned) to assign the user to one or more targeted segments. The assigner module 124 can obtain the set of user characteristic values from the user profile database 120 and/or from the user's activities during the current session. The assigner module 124 can assign a user to one or more defined targeted segments in the segment database 114, or alternatively, the user can be assigned to a custom targeted segment defined to meet specific goals of a content provider.

Based on the assigned segments, the user profile database 120 can be updated to reflect the segment assignments. Additionally, the delivery system 106 can use the segment assignments to select targeted content by looking up the assigned segment in the segment database 114 to obtain candidate targeted content associated with the segment. In some cases, the user profile data in the user profile database 120 can change over time so the assigner module 124 can be configured to periodically update the segment assignments in the user profile database 120. The segment assignment update can be triggered at specified intervals, upon detection of a change in the user profile database 120, and/or upon detection of a specified activity in the delivery system 106.

In some embodiments, the content delivery system 106 can provide a segment-prioritizing module 128 for ordering and re-ordering the targeted segments assigned to a user. The prioritization can be influenced by a number of factors, which include the user's context (state of mind of a user with respect to interest in certain types of content, subject matter of content, progress along a conversion continuum, location, etc.), a content provider's campaign goals, and/or content that is currently available for display to the user. A request to prioritize the targeted segments can be made explicitly or implicitly by any component in the system 100. For example, a secondary content provider 110 can explicitly request that the content delivery system 106 prioritize the targeted segments or the request can be implicit as part of a request for an assembled content package. The resulting prioritized list can be provided, for example, to the content management module 108, which can then use the information to assemble and deliver a content package. Additionally, the prioritized list can be stored, for example in the user profile, for later use.

Once the content management module 108 selects content to be delivered and serves the content to the user, the content delivery system 106 can keep a content usage history database 119 regarding the performance of the delivered content. The content usage history database 119 stores information regarding whether the user interacted with the content (click, conversion, or some other interaction, etc.); it stores contextual information describing the primary content with which the served invitational content was presented; and it stores temporal information describing the time of day or day of week when a user interacted with the content. In short the content usage history database 119 can store any information that is useful in evaluating or understanding the performance (in terms of inviting the desired interaction) of the served content.

Likewise, the content delivery system 106 can also keep track of the circumstances or context around a user's interaction with an item of content served to that user. Such information can be stored in the user profile database 120. For example, relevant information that can be recorded in the user profile database includes: the expected demographic for the content, time of day or day of week the interaction took place, topic of the content, type of content, background color of the invitational content, background color of the primary content, actions that led up to the interaction, etc. In short, any information that is relevant to understanding or evaluating the circumstances leading the user to interact with the content can be recorded in the user profile database 120.

The content delivery system can include one or more modules such as modules employing classification algorithms, machine-learning algorithms, or pattern recognition modules for analyzing the data stored in one or more of the system's databases. In addition to the segment-assigner module 124 and segment-prioritizing module 128, both discussed above, daypart optimization module 126 can be considered among such modules. The daypart optimization module 126 analyzes data, particularly data in the content usage history database 119 and the user profile database 120 to optimize content delivery based on time of day. For example, the daypart optimization module 126 might determine that an item of invitational content performs best during an identified daypart or it might determine that a specific user is more likely to interact with invitational content during an identified daypart. The content management module 108 can use such conclusions to determine the best item of invitational content to serve to a user.

For example, in the instance that the daypart optimization module 126 determines than a specific item of invitational content is more likely to be interacted with on weekday mornings (an identified daypart), the content management module 108 can serve the item of invitational content more often on weekday mornings because the invitational content performs best in this daypart.

In another example, in the instance that a particular user is more likely to interact with invitational content during commuting hours, the content management module might use this information to improve system performance according other system priorities. For example, campaign manager 130 monitors the performance of individual items of invitational content to ensure that content provider campaign goals are being met for each item of invitational content. In some instances, when the campaign manager 130 determines that an item of invitational content is not meeting its campaign goals the segment prioritizing module 128 might prioritize segments associated with the item of invitational content to ensure that the item of invitational content is served to more users. Likewise, the content management module 108 can also prioritize an item of invitational content by serving the item of invitational content to a user during a daypart for which the user is known to be most likely to interact with the invitational content.

In summary, the content delivery system works to match content to users that are most likely to be interested enough in the content to watch or interact with the content. To accomplish this task, the content delivery system collects data and performs many types of analysis on the data to identify patterns and classifications, which are useful in matching content to users. Further, the content delivery system 106 continues to elevate its performance by continuously learning about the content it is distributing and the users it serves and using this refined information to make better-informed decisions for optimizing serving the most relevant content to the users' devices requesting the content.

In the various embodiments, the one or more databases described herein can be implemented using any type of data structures. Such data structures include, but are not limited to, data structures for relational databases, key/value stores, graph databases, hierarchical databases, and distributed or columnar stores. Accordingly, although the various embodiments described herein may refer to specific data structures, in other embodiments, such data structures can be substituted for any other type of data structure.

As described above, one aspect of the present technology is the gathering and use of data available from various sources to improve the delivery of advertisements or any other content that may be of interest to users. The present disclosure contemplates that in some instances, this gathered data may include personal information data that uniquely identifies or can be used to contact or locate a specific person. Such personal information data can include demographic data, location-based data, telephone numbers, email addresses, social media ID's such as TWITTER IDs, home addresses, or any other identifying information.

The present disclosure recognizes that the use of such personal information data in the present technology can be used to the benefit of users. For example, the personal information data can be used to better understand user behavior, facilitate and measure the effectiveness of advertisements, applications, and delivered content. Accordingly, use of such personal information data enables calculated control of the delivered content. For example, the system can reduce the number of times a user receives a given ad or other content and can thereby select and deliver content that is more meaningful to users. Such changes in system behavior improve the user experience. Further, other uses for personal information data that benefit the user are also contemplated by the present disclosure.

The present disclosure further contemplates that the entities responsible for the collection, analysis, disclosure, transfer, storage, or other use of such personal information data should implement and consistently use privacy policies and practices that that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after the informed consent of the users. Additionally, such entities would take any needed steps for safeguarding and securing access to such personal information data and ensuring that others with access to the personal information data adhere to their privacy and security policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for advertisement delivery services. In yet another example, users can configure their devices or user terminals to prevent storage or use of cookies and other mechanisms from which personal information data can be discerned. The present disclosure also contemplates that other methods or technologies may exist for blocking access to their personal information data.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The information gathered about a user, whether public or private can be used directly or indirectly to create the UUID database 116. In many of the embodiments discussed herein, a user is first identified in the UUID database 116 to retrieve, update or write data associated with the user in the UUID database 116.

Identification of the same user in the UUID database can be performed in a variety of ways and the methods employed to identify the user can vary depending on the user's connection type. In one example of identifying a user in the UUID database 116, when the delivery system 106 receives a request for a content package, the request can include some identifying information associated with the requesting user terminal or the associated user. This information can then be correlated to an entry in the UUID database 116 to retrieve an identity of the user. In other configurations, the delivery system 106 can analyze the attributes of the requesting device to determine whether such requests can be attributed to a same device. In some embodiments, a user's behavior in visiting the same content channels can be used to identify the user. Of course combinations of the methods for identifying a user on one or more connection types can be used.

As mentioned above a set of user characteristic values can also be associated with a user in the UUID database 116. In some embodiments, the set of user characteristic values are descriptive of the user. For example, the characteristic values could be demographic characteristics, such as gender, age, ethnicity, and/or income. In some embodiments, the set of user characteristic values are descriptive of the user's interaction with one or more items of content within a network of targeted content delivery channels. For example, the characteristic values can include details of the user's conversion history with respect to previously presented invitational content. The conversion history can be limited to whether or not the user converted or could be more detailed to include where on the conversion continuum the user abandoned the process, details about the invitational content presented, and/or where or when the invitational content was presented. The collected values can further include the channel, the device the user was using, the time of day, and/or day of week. In general, the values can be descriptive of any characteristics associated with the user and the user's actions such as channel, demographic, behavioral, spatial and/or temporal characteristics. The more extensive the data set the more effective the targeting.

As introduced above, the daypart optimization module 126 can perform an analysis of one or more databases within the content delivery system 106 to determine that certain items of invitational content are more likely to be interacted with during identified dayparts. Likewise, some users might also be more likely to interact with content during identified dayparts.

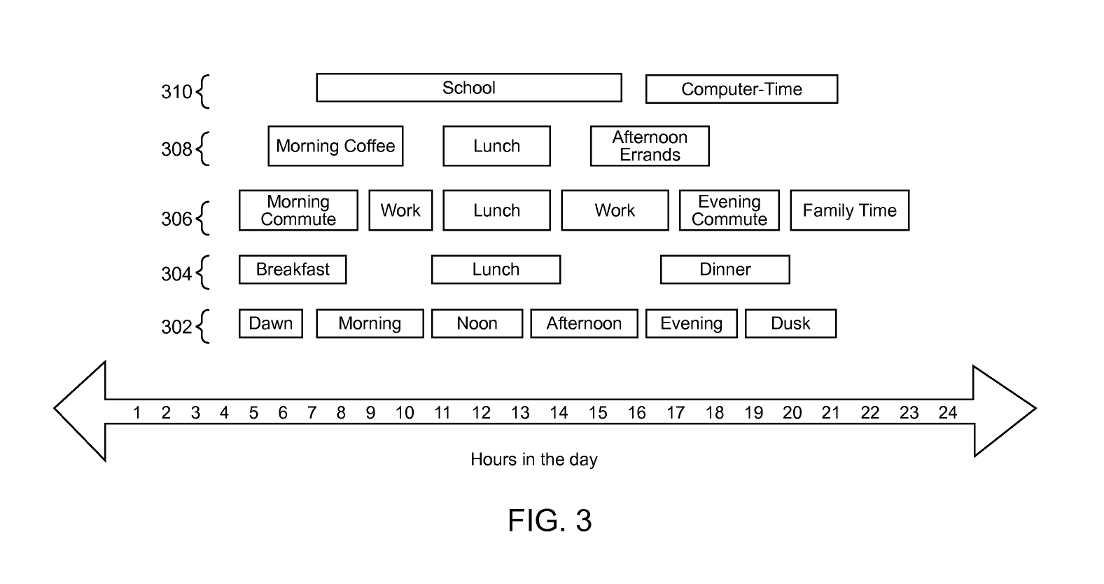

Dayparts can be any identified period of time during a day. Dayparts can even be a specific day of a week or a period within a day of the week. In short, a daypart can be any period of time, regardless of how classified as a day, within a day, or range of days. For example, FIG. 3 illustrates a variety of different dayparts that can be associated with a weekday. 302 illustrates that the weekday can be divided into dayparts comprising common periods of the day such as dawn, morning, noon, afternoon, evening, dusk, etc. 304 illustrates that dayparts can be based on common meal periods such as breakfast, lunch, and dinner, etc. 306 illustrates that dayparts can include divisions of a typical workday such a morning commute, work, lunch, work, evening commute, and family time, etc. 308 illustrates another division of a typical work day which focuses on non-work periods within the work day including a coffee break, lunch, and afternoon errands, etc. 310 illustrates dayparts associated with a school day including time at school and computer-time for doing home work or chatting with friends, etc.

The illustrated divisions of dayparts should not be considered exclusive. The dayparts illustrated in 302, 304, 306, 308 and 310 can all be used by the system. Different dayparts might apply to different content or different users, or some content and some users can be assigned to multiple overlapping dayparts. For example, a person or content that is associated with morning conversions could be associated with each category dawn, morning, breakfast, morning commute, morning coffee—as applicable to a given user or invitational content. Other dayparts can also be used as their relevance in serving content is identified.

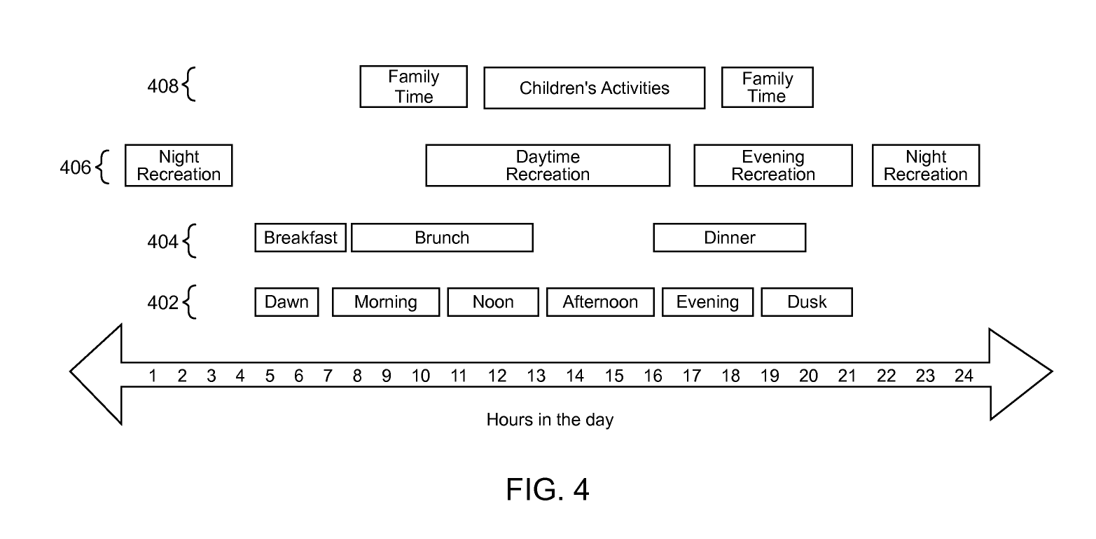

FIG. 4 also illustrates different dayparts, but the illustrated dayparts are associated with a Saturday or Sunday or other non-work day such as a holiday. The figure illustrates that different days can have different dayparts associated with them. In the case of a weekend, 402 illustrates that the weekend can be divided into dayparts comprising common periods of the day such as dawn, morning, noon, afternoon, evening, dusk, etc. 404 illustrates that dayparts can be based on common weekend meal periods such as breakfast, brunch, and dinner, etc. 406 illustrates that dayparts can be based on recreation periods such as daytime recreation, evening recreation, and night recreation, etc. 408 illustrates dayparts that might be applicable to a person having a family on a weekend including family time and children's activities.

While not separately illustrated, a daypart can also be a specific day of the week. For example, invitational content might be interacted with more often on Wednesday and Thursdays because people are typically less motivated on those days of the week. The days themselves can be dayparts or the individual days can have dayparts tailored to the unique attributes of the specific day.

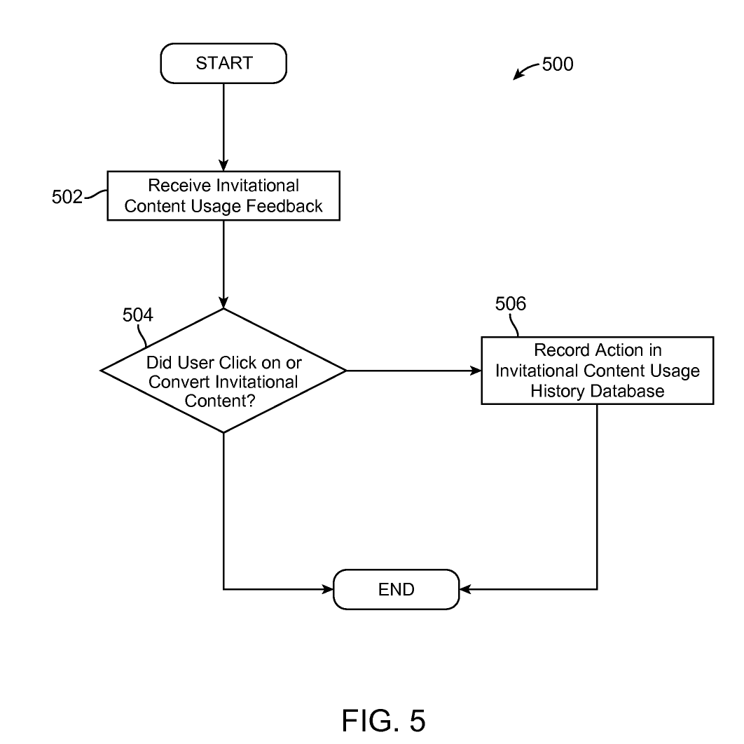

FIG. 5 illustrates an exemplary method 500 of recording time information associated with a click, conversion, or other interaction with an item of invitational content. At 502, the content delivery system receives feedback from the user's device reporting on the user's interaction or lack thereof with an item of invitational content that was previously served by the content delivery system and presented to the user by the user's device. At 504, the content delivery system determines whether the user interacted with the item of content and if so, records the type of interaction in the invitational content usage history database at 506. With specific relevance to the embodiments described herein, the record of the interaction includes at least some information describing the type or nature of the interaction and a time stamp including the time of day and the date or day of the week.

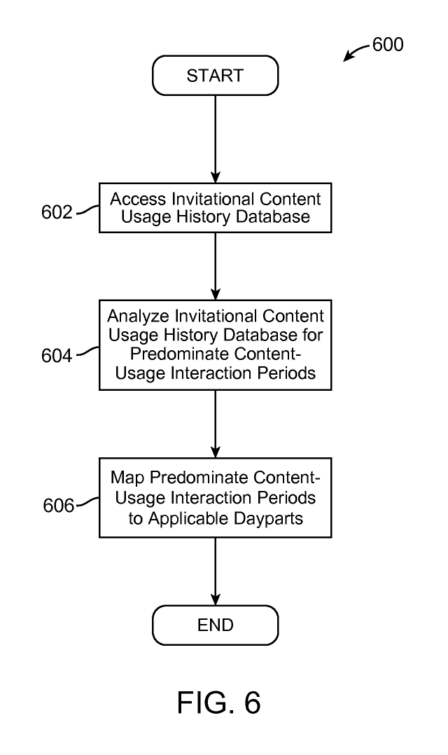

FIG. 6 illustrates an exemplary method 600 of associating an item of invitational content with dayparts. At 602, the daypart optimization module accesses the invitational content usage history database and analyzes the data at 604. The analysis can be performed using any number of algorithmic techniques for determining the predominant periods when the item of invitational content is being interacted with. For example, creating a frequency graph or a cluster analysis or any other suitable analytic method can be used to perform the analysis. The identified, predominant, usage interaction periods are then mapped or assigned to any defined dayparts at 606, which results in creating a relationship between the item of invitational content and the daypart(s) for later use in selecting the item of invitational content for distribution to users.

In some embodiments, the daypart optimization module can also attempt to predict which dayparts an item of invitational content will become associated with before the system has enough data on that item to associate the item with a daypart based on historical performance. In such embodiments, the content delivery system can identify a new item of invitational content as similar to an existing item of invitational content and predict its performance based on the similarities between the items of invitational content.

Likewise, a categorizing algorithm can also be used to associate items of invitational content having a particular topic or other characteristics with a daypart. For example, items of invitational content having morning related themes, or associated with morning related content such as coffee, breakfast, etc. can be associated with dayparts covering morning hours without reviewing historical performance of the invitational content.

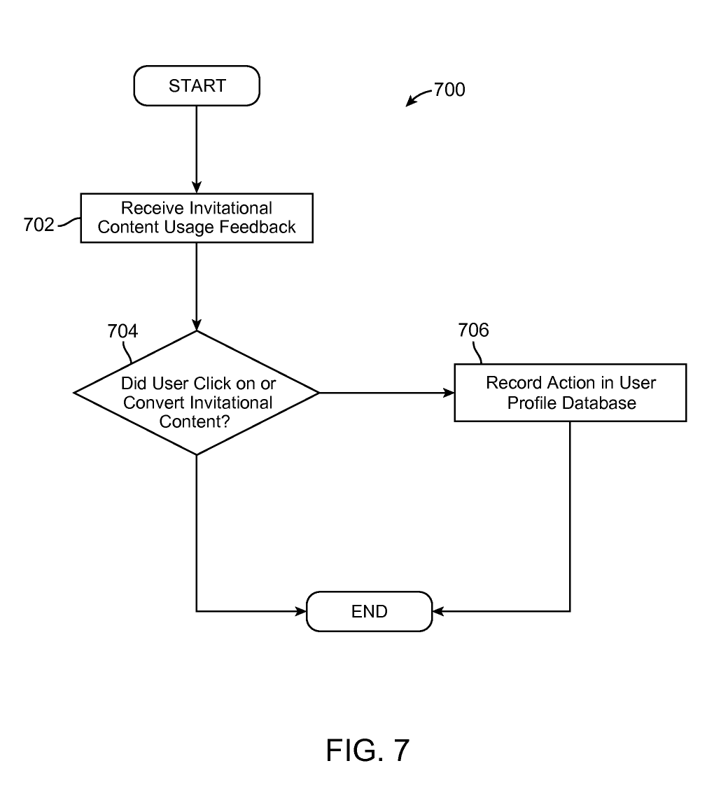

FIG. 7 illustrates an exemplary method 700 of recording time information associated with a click, conversion, or other interaction by an identified user. At 702, the content delivery system receives feedback from the user's device reporting on the user's interaction or lack thereof with an item of invitational content that was previously served by the content delivery system and presented to the user by the user's device. At 704, the content delivery system determines whether the user interacted with the item of content and, if so, records the type of interaction in the user profile database at 706. With specific relevance to the embodiments described herein, the record of the interaction includes at least some information describing the type or nature of the interaction and a time stamp including the time of day and the date or day of the week.

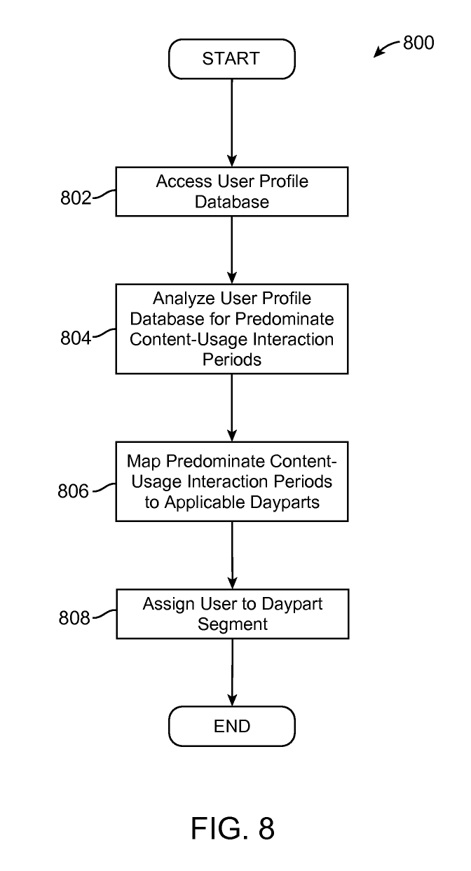

FIG. 8 illustrates an exemplary method 800 of associating a user's interaction history with dayparts. At 802, the daypart optimization module accesses the user profile database and analyzes the data at 804. The analysis can be performed using any number of algorithmic techniques for determining the predominant periods when the user is interacting with items of invitational content. For example, creating a frequency graph or a cluster analysis or any other suitable analytic method can be used to perform the analysis. The identified, predominant usage interaction periods are then mapped to any defined dayparts at 806 that encompass the periods of interaction, which results in creating a relationship between the user and the daypart(s) for later use in selecting the item of invitational content for distribution the user.

In some embodiments, segments can also be associated with dayparts (808). Since both content and users are associated with segments, an analysis of performance of the content associated with the segment or the user profiles of the users associated with the segment can be used to identify and assign a relationship of the segment to the daypart. Such analysis can be performed in a similar fashion as described above for an item of content or a single user, but looking at a larger dataset when examining segments.

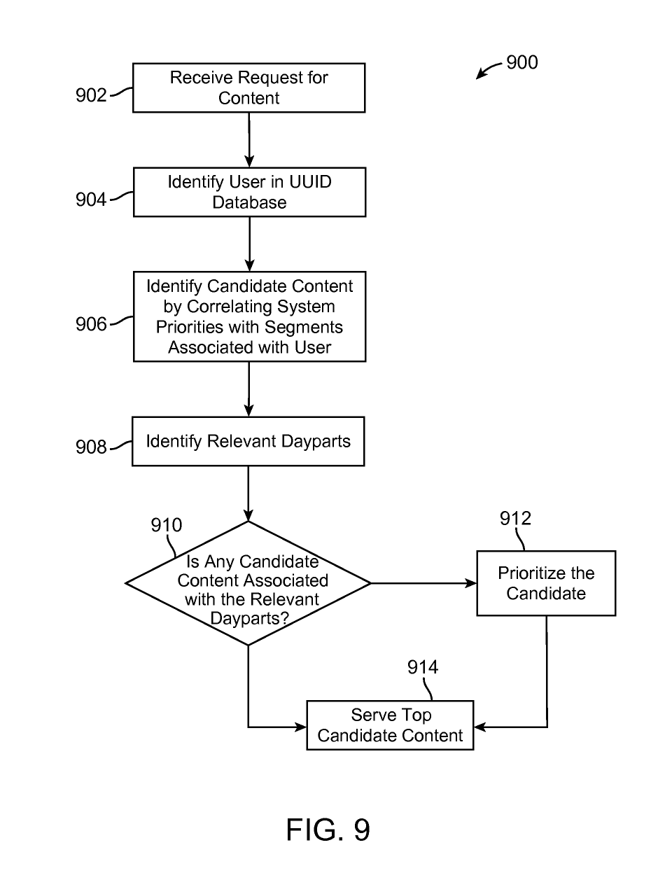

FIG. 9 illustrates an exemplary method of selecting an item of invitational content to serve to a user while taking into account daypart data. At 902, the content delivery system receives a request for content from a user's device. The content delivery system identifies the user in the UUID database at 904. Using the user's UUID, the content delivery system identifies population segments that are associated with the UUID to identify candidate content at 906. Additionally, the content management module may utilize additional information or modules to determine an ordering of the candidate content from which one of the top candidates in the ordering can be chosen. For example, the segment prioritization module can be used to determine which segments are being prioritized by the system. Accordingly, the content associated with the most prioritized system segment that is also associated with the user would be at the top of the order for serving.

In addition, other system priorities or information can also be taken into account by the content management module. For example, one priority is to increase the general efficacy of the system in successfully inviting user interaction with the served content. At 908, the system can identify relevant dayparts. The dayparts are relevant because they correspond to time periods overlapping with the time of the request for content. The content management module can determine if any of the top candidates for serving to the user is associated with the relevant daypart at 910. If the content management module identifies a candidate associated with one of the relevant dayparts, it can move that candidate up the order at 912 and serve the top candidate to the user's device to fulfill the request at 914. If there is not a candidate associated with the relevant daypart, the system can proceed to 914 and serve the top candidate based on other system priorities, such as a segment priority order.

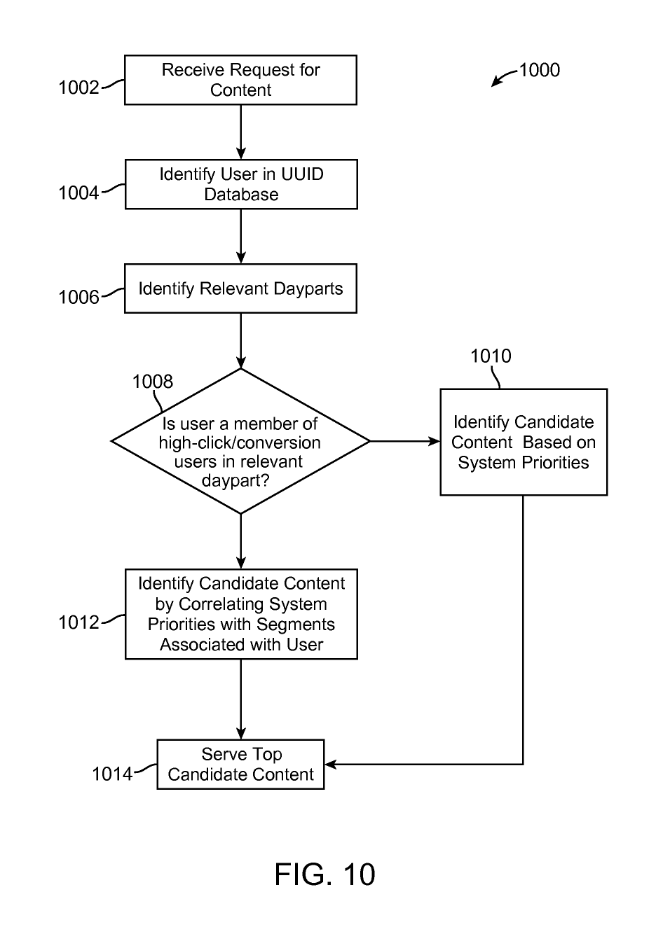

FIG. 10 illustrates an exemplary method 1000 of selecting an item of invitational content to serve to a user based on the user's history of being a high converter during the present daypart. At 1002, the content delivery system receives a request for content from a user's device. The content delivery system identifies the user in the UUID database at 1004. Using the user's UUID, the content delivery system identifies dayparts for which the user is known to be more likely to interact with served content at 1006. The content delivery system determines if any of the dayparts are relevant to the present time of day at 1008. The dayparts are relevant because they correspond to time periods overlapping with the time of the request for content. If the user is determined to be a member of a relevant daypart at 1008, the content management module determines which content to serve to the user based on system priorities at 1010.

System priorities can include a preference for one segment over other segments, or they can include a prioritization of a particular campaign associated with an item of invitational content. Since the user has a known predisposition to be more likely to interact with content that is served to him during the relevant daypart, the user can be considered a useful asset in meeting system goals. For example, if a content provider provided content with the expectation that at least certain number of users would interact with the content, the content delivery system strives to fulfill that expectation. Thus, if an item of invitational content is under performing due to competing system priorities or just unappealing content, the content management module can select the item of invitational content as a top candidate and serve it to the user to improve the performance of the campaign.

Other priorities include a general system priority to result in having a user interact with as much content as possible, which necessarily requires serving well-targeted content. Selecting content that is highly aligned with the user's interest, during relevant dayparts, is aligned with the system's priorities of keeping the user interested in content being served by the system.

Other priorities can include campaign goals of focusing on users during dayparts when they are known to have a predisposition towards interacting with content. To the extent that the content delivery system is associated with a business, the content delivery system can charge extra for prioritizing certain content to these high value users.

In any event, the content management module can identify content based on system priorities and serve a top candidate to a user based in part on the user's known predisposition towards interacting with content during the relevant daypart.

If at 1008 the user is not found to be associated with any relevant daypart, the content management module can serve content (1014) based on identified segments and their prioritization (1012) as addressed above.

Using the foregoing methods and systems, invitational content can be served to a user taking into account temporal considerations. By using temporal considerations, such as dayparts having a relationship to the content or the user, the content delivery system can better associate content to users to increase the relevance of the content to the user, to increase the user's interest in the content, and to increase the performance of the content delivery system as judged by the meeting of system objectives, among other benefits.

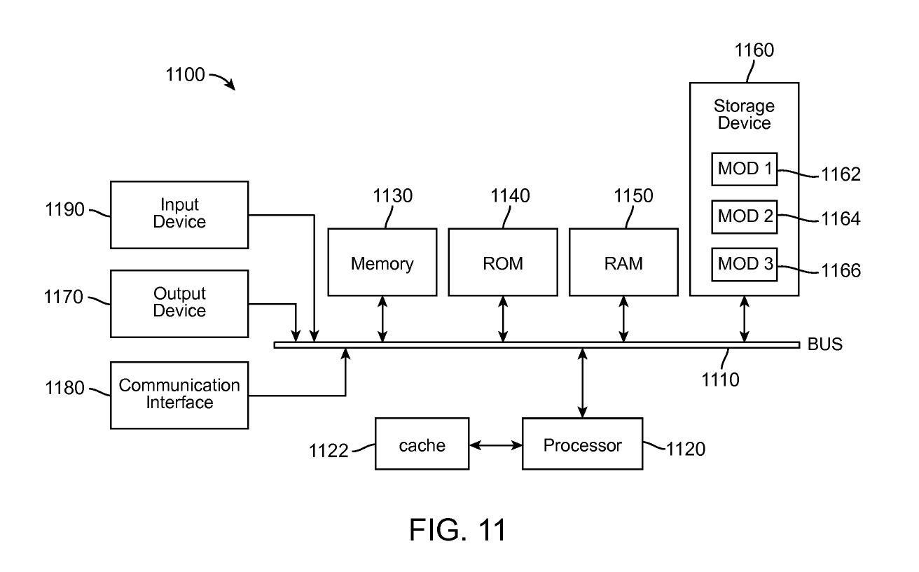

With reference to FIG. 11, an exemplary system 1100 includes a general-purpose computing device 1100, including a processing unit (CPU or processor) 1120 and a system bus 1110 that couples various system components including the system memory 1130 such as read only memory (ROM) 1140 and random access memory (RAM) 1150 to the processor 1120. The system 1100 can include a cache 1122 of high-speed memory connected directly with, in close proximity to, or integrated as part of the processor 1120. The system 1100 copies data from the memory 1130 and/or the storage device 1160 to the cache 1122 for quick access by the processor 1120. In this way, the cache 1122 provides a performance boost that avoids processor 1120 delays while waiting for data. These and other modules can be configured to control the processor 1120 to perform various actions. Other system memory 1130 may be available for use as well. The memory 1130 can include multiple different types of memory with different performance characteristics. It can be appreciated that the disclosure may operate on a computing device 1100 with more than one processor 1120 or on a group or cluster of computing devices networked together to provide greater processing capability. The processor 1120 can include any general purpose processor and a hardware module or software module, such as module 1 1162, module 2 1164, and module 3 1166 stored in storage device 1160, configured to control the processor 1120 as well as a special-purpose processor where software instructions are incorporated into the actual processor design. The processor 1120 may essentially be a completely self-contained computing system, containing multiple cores or processors, a bus, memory controller, cache, etc. A multi-core processor may be symmetric or asymmetric.

The system bus 1110 may be any of several types of bus structures including a memory bus or memory controller, a peripheral bus, and a local bus using any of a variety of bus architectures. A basic input/output (BIOS) stored in ROM 1140 or the like, may provide the basic routine that helps to transfer information between elements within the computing device 1100, such as during start-up. The computing device 1100 further includes storage devices 1160 such as a hard disk drive, a magnetic disk drive, an optical disk drive, tape drive or the like. The storage device 1160 can include software modules 1162, 1164, 1166 for controlling the processor 1120. Other hardware or software modules are contemplated. The storage device 1160 is connected to the system bus 1110 by a drive interface. The drives and the associated computer-readable storage media provide nonvolatile storage of computer-readable instructions, data structures, program modules and other data for the computing device 1100. In one aspect, a hardware module that performs a particular function includes the software component stored in a non-transitory computer-readable medium in connection with the necessary hardware components, such as the processor 1120, bus 1110, display 1170, and so forth, to carry out the function. The basic components are known to those of skill in the art and appropriate variations are contemplated depending on the type of device, such as whether the device 1100 is a small, handheld computing device, a desktop computer, or a computer server.

Although the exemplary embodiment described herein employs the hard disk 1160, it should be appreciated by those skilled in the art that other types of computer-readable media which can store data that are accessible by a computer, such as magnetic cassettes, flash memory cards, digital versatile disks, cartridges, random access memories (RAMs) 1150, read only memory (ROM) 1140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 1100, an input device 1190 represents any number of input mechanisms, such as a microphone for speech, a touch-sensitive screen for gesture or graphical input, keyboard, mouse, motion input, speech and so forth. An output device 1170 can also be one or more of a number of output mechanisms known to those of skill in the art. In some instances, multimodal systems enable a user to provide multiple types of input to communicate with the computing device 1100. The communications interface 1180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 1120. The functions these blocks represent may be provided through the use of either shared or dedicated hardware, including, but not limited to, hardware capable of executing software and hardware, such as a processor 1120, that is purpose-built to operate as an equivalent to software executing on a general purpose processor. For example the functions of one or more processors presented in FIG. 11 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 1140 for storing software performing the operations discussed below, and random access memory (RAM) 1150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer; (2) a sequence of computer implemented steps, operations, or procedures running on a specific-use programmable circuit; and/or (3) interconnected machine modules or program engines within the programmable circuits. The system 1100 shown in FIG. 11 can practice all or part of the recited methods, can be a part of the recited systems, and/or can operate according to instructions in the recited computer-readable storage media. Such logical operations can be implemented as modules configured to control the processor 1120 to perform particular functions according to the programming of the module. For example, FIG. 11 illustrates three modules Mod1 1162, Mod2 1164 and Mod3 1166 which are modules controlling the processor 1120 to perform particular steps or a series of steps. These modules may be stored on the storage device 1160 and loaded into RAM 1150 or memory 1130 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

1. A computer-implemented method comprising:
identifying dayparts that are correlated to variations in conversion frequency of items of invitational content;
associating an item of invitational content with a daypart for which the correlated variation in conversion frequency indicates that it is more likely that the item of invitational content will be converted during the daypart; and
prioritizing delivery of the item of invitational content to a user during the associated daypart.

2. The computer-implemented method of claim 1, wherein the association of the item of invitational content with the daypart comprises:
associating a segment, which is further associated with at least the item of invitational content, with the daypart for which the correlated variation in conversion frequency indicates that it is more likely that item of invitational content will be converted during the daypart.

3. The computer-implemented method of claim 2, wherein the prioritizing the delivery of the item of invitational content to a user comprises:
prioritizing a segment during a daypart for which the segment is associated.

4. The computer-implemented method of claim 3, where the prioritizing of a segment is a rearrangement of a general segment prioritization scheme.

5. The computer-implemented method of claim 1, wherein the indication that it is more likely that the item of invitational content will be converted during the daypart is determined based on an analysis of the invitational content's past performance.

6. The computer-implemented method of claim 1, wherein the indication that it is more likely that the item of invitational content will be converted during the daypart is determined based on an analysis of the user's habits.

7. The computer-implemented method of claim 1, wherein the indication that it is more likely that the item of invitational content will be converted during the daypart is determined based on a comparison of the item of invitational content with other similar items of invitational content.

8. The computer-implemented method of claim 1, wherein the indication that it is more likely that the item of invitational content will be converted during the daypart is determined based on a classifying algorithm that associates the item of invitational content with the daypart.

9. The computer-implemented method of claim 8, wherein the classifying algorithm is configured to analyze the item of invitational content for a content type or other characteristic which is determined to be more likely to be converted during the daypart.

10. A computer-readable medium having computer-readable code stored thereon, the computer-readable code being effective to cause a computer to perform the method comprising:
identifying dayparts that are correlated to variations in conversion frequency of items of invitational content, the items of invitational content being associated with a segment;
associating a segment with a daypart for which the correlated variation in conversion frequency indicates that it is more likely that one of the items of invitational content associated with the segment will be converted during the daypart; and
prioritizing the segment during the associated daypart.

11. The computer-readable medium of claim 10, further comprising:
selecting an item of invitational content from the items of invitational content that are associated with the segment.

12. The computer-readable medium of claim 10, wherein the indication that it is more likely that the one of the items of invitational content will be converted during the daypart is determined based on an analysis of the invitational content's past performance.

13. The computer-readable medium of claim 10, wherein the indication that it is more likely that the one of the items of invitational content will be converted during the daypart is determined based on an analysis of the user's habits.

14. The computer-readable medium of claim 10, wherein the indication that it is more likely that the one of the items of invitational content will be converted during the daypart is determined based on a comparison of the item of invitational content with other similar items of invitational content.

15. The computer-readable medium of claim 10, wherein the indication that it is more likely that the one of the items of invitational content will be converted during the daypart is determined based on a classifying algorithm that associates the item of invitational content with the daypart.

16. The computer-readable medium of claim 10, wherein the classifying algorithm is configured to analyze the item of invitational content for a content type or other characteristic which is determined to be more likely to be converted during the daypart.

17. A content delivery system comprising:
a database of information describing user interactions with invitational content and temporal information related to the interactions;
a daypart optimization module configured to analyze the database to identify periods of time wherein a predominate amount of user interactions with invitational content occurred;
a content management module configured to select an item of invitational content for delivery to a user device based on the analysis of the daypart optimization module; and
a communications interface configured to transmit the item of invitational content selected by the content management module.

18. The content delivery system of claim 17, wherein the analysis of the database by the daypart optimization module results in a identification of one or more periods of time when a specific item of invitational content is more likely to be interacted with by the users of the system.

19. The content delivery system of claim 17, wherein the analysis of the database by the daypart optimization module results in a identification of one or more periods of time when an identified user is more likely to be interact with invitational content transmitted from the system.

20. The content delivery system of claim 17, wherein the content management module selects and item of invitational content for delivery by first identifying a set of candidate items before determining if one of the items is associated with a current period, and upon identifying one of the items is associated with the current period, the content management module prioritizes that item for delivery.

21. The content delivery system of claim 17, wherein analysis by the daypart optimization module identifies periods of time wherein a predominate amount of user interactions with invitational content occurred based on an analysis of the invitational content's past performance.

22. The content delivery system of claim 17, wherein analysis by the daypart optimization module identifies periods of time wherein a predominate amount of user interactions with invitational content occurred based on an analysis of the user's habits.
